(19) United States
(12) Patent Application Publication
(10) Pub. No.: US 2018/0121084 A1
(43) Pub. Date: May 3, 2018

(54) INFORMATION DISPLAY DEVICE

(71) Applicant: Sharp Kabushiki Kaisha, Osaka (JP)

(72) Inventors: Kiho SAKAMOTO, Sakai City (JP); Satoshi TERADA, Sakai City (JP); Hiroki MUNETOMO, Sakai City (JP)

(21) Appl. No.: 15/795,432

(22) Filed: Oct. 27, 2017

(30) Foreign Application Priority Data
Oct. 28, 2016 (JP) 2016-211668

(51) Int. Cl. G06F 3/0488; G06F 3/14; G06F 3/041; G06F 3/0484

(52) U.S. Cl. CPC G06F 3/04886; G06F 3/1454; G06F 3/04842; G06F 3/0412; G06F 3/0416

(57) ABSTRACT

An information display device includes: a display unit that simultaneously displays one or more images; a storage unit that stores one or more pieces of arrangement information each indicating an arrangement of one or more images displayed on the display unit on a per image basis and each being associated with a subject among one or more subjects related to storage and reproduction of display content; a list generation unit that generates a subject-basis list so as to allow selection of an arrangement of one or more images to be reproduced on the display unit for a subject; an operation unit that accepts selection of a subject by a user using the subject-basis list; and a layout reproduction unit that reproduces an arrangement of one or more images on the display unit on the basis of a piece of arrangement information associated with the selected subject.

### BACKGROUND

### 1. Field

The present disclosure relates to an information display device. More specifically, the present disclosure relates to an information display device that displays and manages materials including documents and images related to a subject that is addressed in, for example, a meeting, a lecture, a speech, a lesson, or a presentation (for example, the agenda of a meeting, the theme of a lecture, the theme of a speech, or the subject of a lesson).

### 2. Description of the Related Art

Currently, a display device called an electronic whiteboard that displays materials on the large screen of the display device and allows electronic writing to the display screen is widely used in a case of, for example, a meeting, a lecture, or a presentation. Such a display device is used as an electronic whiteboard to thereby facilitate, for example, a meeting, a lecture, and a presentation.

An electronic whiteboard is typically used in, for example, a meeting. An electronic whiteboard is a device that is developed by extending the functions of a blackboard or a whiteboard that is usually used to write proceedings and to share a common understanding among participants. An electronic whiteboard is capable of displaying materials and printing and saving minutes.

An electronic whiteboard is capable of displaying various types of documents, images, or a combination thereof (hereinafter simply referred to as documents) that are created by using software, such as presentation software, document creation software, spreadsheet software, drawing software, or a text editor. In general, in order to display such a document, software that is used to create data of the document needs to be used. An electronic whiteboard is capable of displaying a document that is converted to, for example, a PDF document. Further, an electronic whiteboard is capable of displaying a moving image. That is, an electronic whiteboard can be regarded as a type of information processing device.

A situation where various types of materials are simultaneously displayed for one topic and a discussion takes place about the topic occurs frequently. Meanwhile, a plurality of topics may be addressed in a single meeting. In this case, it is desirable that materials related to different topics can be easily distinguished from each other so as not to cause confusion. Further, about one topic, a plurality of meetings may be held at separate dates and times. In this case, if the last state in the previous meeting can be reproduced for the topic, the meeting can be continued more easily.

Regarding the above-described issue, a technique in which an operation for changing a display screen of an information process device is recorded, a thumbnail of the display screen is generated in accordance with the recorded operation, and a display screen that corresponds to a selected thumbnail is reproduced has been proposed (see, for example, Japanese Unexamined Patent Application Publication No. 2013-161302).

Further, an information processing environment management device has been proposed that assumes a case where a specific user uses any information processing device and that ensures the continuity of a work state in an office environment in which the user moves to various physical spaces (see, for example, Japanese Unexamined Patent Application Publication No. 2005-044159). In the information processing environment management device according to Japanese Unexamined Patent Application Publication No. 2005-044159, for example, a tag reader is used as a unit for recognizing a user and, when the user ends their work, the work state is detected and retained in a work state retaining unit. When the user starts their work using any information processing device located in a movement destination, the work state of the user who is recognized is read from the work state retaining unit to reproduce the previous work state.

Further, an information processing device for appropriately reproducing a meeting even for a different display device configuration has been proposed (see, for example, Japanese Unexamined Patent Application Publication No. 2013-126127). The information processing device according to Japanese Unexamined Patent Application Publication No. 2013-126127 uses a screen displayed on a display device when proceedings information is input to generate an image for reproduction, and performs a process for associating the image for reproduction with the proceedings information. When the proceedings information is reproduced, if configuration information to be used is different from that of the display device used at the time of input, the information processing device displays the image for reproduction in accordance with an arrangement different from an arrangement used at the time of input.

An information processing device, such as an electronic whiteboard described above, that is assumed to mainly display materials and that has a function of accepting an operation to the display screen and allowing electronic writing to the display screen is called an information display device herein.

As a method for distinguishing materials related to different topics from each other, a function of storing together, for each topic, materials related to the topic may be provided. When materials are stored together, the arrangement of material images on an entire display unit might not be reproduced, and all materials related to the topic might not be displayed on the screen at all times.

A method may be employed in which a function of storing the arrangement of material images at a specific time point, such as a screen snapshot, is provided. If a large number of screen snapshots are stored, a user may be unable to easily identify a screen snapshot that the user wants to retrieve.

### SUMMARY

In view of the above-described issue, the present disclosure provides an information display device with which materials related to different topics can be easily distinguished from each other and with which the arrangement of material images of materials displayed on a display unit at a past specific time point can be easily reproduced.

According to an aspect of the disclosure, there is provided an information display device including a display unit, a storage unit, a list generation unit, an operation unit, and a layout reproduction unit. The display unit simultaneously displays one or more images. The storage unit stores one or more pieces of arrangement information each indicating an arrangement of the one or more images displayed on the display unit on a per image basis, each of the one or more pieces of arrangement information being associated with a subject among one or more subjects related to storage and reproduction of display content. The list generation unit generates a subject-basis list so as to allow selection of an arrangement of one or more images to be reproduced on the display unit for a subject among the one or more subjects. The operation unit accepts selection of a subject from among the one or more subjects by a user using the subject-basis list. The layout reproduction unit reproduces an arrangement of one or more images on the display unit on the basis of a piece of arrangement information associated with the selected subject.

### BRIEF DESCRIPTION OF THE DRAWINGS

FIG. 1 is a front view illustrating an appearance of an information display device according to a first embodiment;

FIG. 2 is a block diagram illustrating an electrical configuration of the information display device according to the first embodiment;

FIG. 3 is an explanatory diagram illustrating a state where material images are displayed on a display unit of the information display device illustrated in FIG. 1;

FIG. 4 is a flowchart illustrating a display process performed by a control unit in the first embodiment when the information display device is activated;

FIG. 5 is an explanatory diagram illustrating an example of a meeting management screen according to the first embodiment;

FIG. 6 is a flowchart illustrating an overview of a display process performed by the control unit in the first embodiment;

FIG. 7 includes explanatory diagrams illustrating data in a subject storing unit, data in a drawer storing unit, and data in an arrangement information storing unit in the first embodiment;

FIG. 8 is a flowchart illustrating a process performed by the control unit in the first embodiment when a meeting ends;

FIG. 9 is an explanatory diagram illustrating points of the display process according to the first embodiment;

FIG. 10 is a flowchart illustrating an overview of a display process performed by the control unit in a third embodiment; and

FIG. 11 is an explanatory diagram illustrating an example of the meeting management screen according to a fifth embodiment.

### DESCRIPTION OF THE EMBODIMENTS

Hereinafter, embodiments of the present disclosure will be described in detail with reference to the drawings. Note that a description given below is illustrative in all aspects and is not construed as restrictive.

### First Embodiment

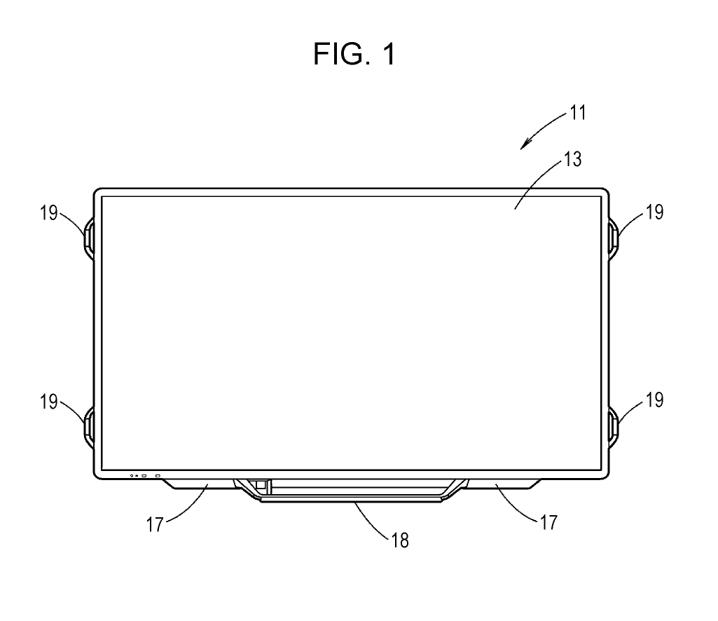

FIG. 1 is a front view illustrating an appearance of an information display device 11 according to a first embodiment.

As illustrated in FIG. 1, the information display device 11 includes a display unit 13, which occupies most of the front part of the information display device 11. The display unit 13 is, for example, a liquid crystal display panel but is not limited to a display of this type. The display unit 13 may be a display device according to another method, such as an organic electroluminescence (EL) display. When a user touches the surface of the display unit 13 with an electronic pen or their fingertip, a touch sensor that functions as an operation unit 15 (not illustrated in FIG. 1) detects the touching and the touched position. In a center portion below the display unit 13, a tray 18 on which an electronic pen and so on are put is provided. To the right and the left of the tray 18, speakers 17 are provided. On each of the right side and the left side of the display unit 13, two handles 19 for carrying are provided in an upper portion and a lower portion.

### Configuration of Information Display Device and Configuration of Screen

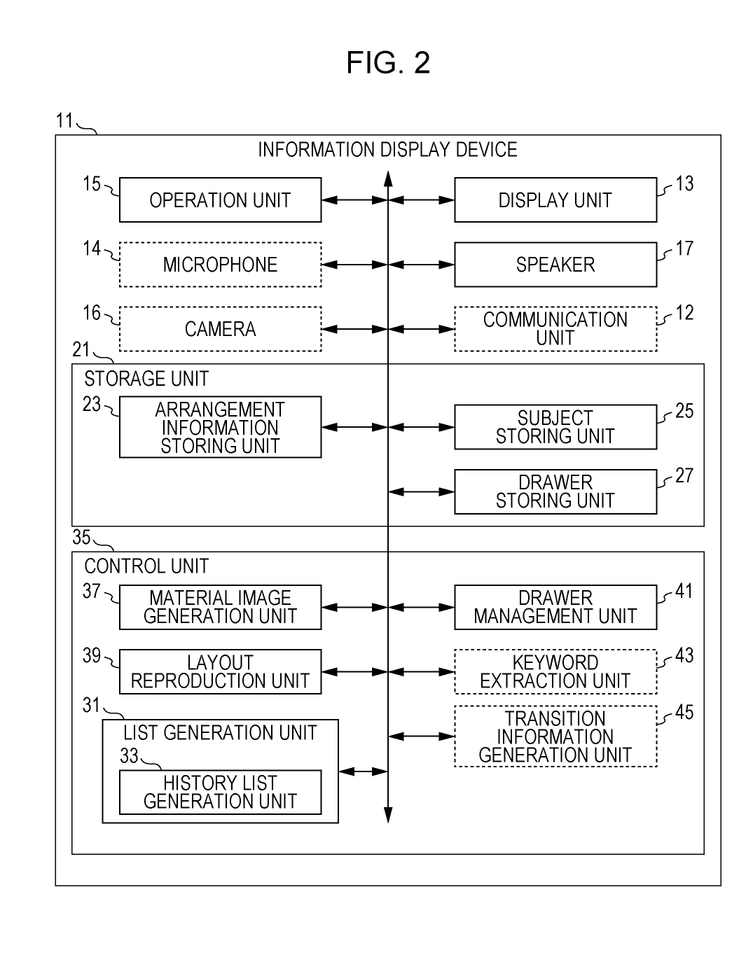

FIG. 2 is a block diagram illustrating an electrical configuration of the information display device 11 according to the first embodiment. A block outlined by a chain line corresponds to a constituent element that is an optional element.

As illustrated in FIG. 2, the information display device 11 includes a touch sensor that functions as the operation unit 15, which is not illustrated in FIG. 1, a control unit 35, and a storage unit 21 in addition to the display unit 13 and the speakers 17, which are illustrated in FIG. 1. The touch sensor may be, for example, a capacitive touch panel but is not limited to a touch sensor of this type. The touch sensor may be a touch sensor of another type, such as an infrared touch sensor. The information display device 11 may further include a communication unit 12, which is a communication interface for communication with an external device. The communication method is not limited to a specific method. The information display device 11 may further include a microphone 14 and a camera 16.

The storage unit 21 includes a random access memory (RAM) that provides a work area when a central processing unit (CPU), which is the center of the control unit 35, performs processing, and further includes a nonvolatile storage device constituted by a flash memory or a hard disk drive. The storage unit 21 stores a control program executed by the CPU. The storage unit 21 has a storage area that is provided as an arrangement information storing unit 23, a subject storing unit 25, and a drawer storing unit 27 for storing data.

The arrangement information storing unit 23 stores pieces of arrangement information, each of the pieces of arrangement information being information regarding the arrangement of material images displayed on the display unit 13. Arrangement information includes information regarding each material image and is managed in association with a subject that is related to the material image. A material image is managed in association with information used to identify original material data of the material image.

Here, material data is a data file of any of the various types of documents (that may include an image) created by using software, such as presentation software, document creation software, spreadsheet software, drawing software, or a text editor. Specific examples of material data include text data created by using a text editor and PDF data obtained by converting the text data to data in a PDF format. Material data can be opened by using corresponding application software.

A material image is image data obtained by converting material data described above to an image and is associated with the original material data. A material image is image data, and therefore, can only be, for example moved, enlarged/reduced, or rotated. For example, when a request for, for example, a page flip is accepted for a material image, the control unit 35 needs to perform a process for opening original material data, converting the next page to an image, and replacing the material image currently displayed with the image obtained as a result of the conversion. Alternatively, the control unit 35 may convert all pages to images at once when opening the original material data.

The subject storing unit 25 stores subjects related to display on the information display device 11. Each of the pieces of arrangement information stored in the arrangement information storing unit 23 is associated with one of the subjects stored in the subject storing unit 25. The subject storing unit 25 stores data that indicates association between subjects and the pieces of arrangement information.

The drawer storing unit 27 stores reference destinations (address information). In each of the reference destinations, one or more pieces of material data are stored together. Specifically, the drawer storing unit 27 stores file paths for referring to file folders in which information used to identify pieces of material data is stored. A user may determine pieces of material data to be stored together. It is assumed that, for example, pieces of material data related to one subject are stored together. Arrangement information regarding each piece of material data is not stored in the drawer storing unit 27. The number of drawers is one or more. In the first embodiment, three drawers are provided, and each drawer stores a file path. Usually, the drawers store different file paths. If a user sets the same file paths for the drawers, such setting is used regardless of whether the setting is useful.

A mode may be employed in which a file path associated with a drawer can be set for each subject. This mode will be described as another embodiment (see a third embodiment). In the first embodiment, a file path associated with a drawer is common to all subjects regardless of a selected subject.

The control unit 35 is an electronic circuit constituted mainly by the CPU. The CPU executes the control program stored in the storage unit 21 to implement the functions of a list generation unit 31, a history list generation unit 33, a material image generation unit 37, a layout reproduction unit 39, and a drawer management unit 41. The CPU may execute the control program to implement the functions of a keyword extraction unit 43 and a transition information generation unit 45.

The list generation unit 31 generates a list of thumbnails for each subject, each of the thumbnails representing the arrangement of material images displayed on the display unit 13 at a specific time point. The list of thumbnails is used as reference information for a user to select a subject for which display is to be reproduced.

The history list generation unit 33 generates, when the list generation unit 31 generates a list of thumbnails for each subject, generates thumbnails indicating the arrangements of material images for the same topic at different time points as different thumbnails. Therefore, transitions (history) of material images displayed on the display unit 13 for a specific topic (subject) can be viewed as thumbnails.

A mode may be employed in which thumbnails in the history are used and a user selects, for a specific topic, a time point for which display is to be reproduced. This mode will be described as another embodiment (see a second embodiment). In the first embodiment, display of the latest material images for a selected topic is reproduced.

The material image generation unit 37 generates image data (hereinafter referred to as a material image or a sheet) that is displayed on the display unit 13 on the basis of the content of material data.

The layout reproduction unit 39 refers to the arrangement information storing unit 23 for a subject selected by a user and performs a process for reproducing display of the latest material images and the arrangement of the material images on the display unit 13.

The drawer management unit 41 processes a user operation for a drawer. For example, the drawer management unit 41 displays drawers on the display unit 13 to allow a user to select a drawer. When the user selects a drawer, the drawer management unit 41 displays a list of pieces of material data registered in the drawer on the display unit 13 to allow the user to make selection.

When the user makes selection so as to display the content of one of the pieces of material data, the drawer management unit 41 instructs the material image generation unit 37 to generate a material image of the selected piece of material data to display the material image on the display unit 13. When the user selects a drawer and performs an operation of adding a piece of material data, the drawer management unit 41 adds the piece of material data to the selected drawer. Specifically, the drawer management unit 41 stores information used to identify the piece of material data in a file folder that the drawer refers to.

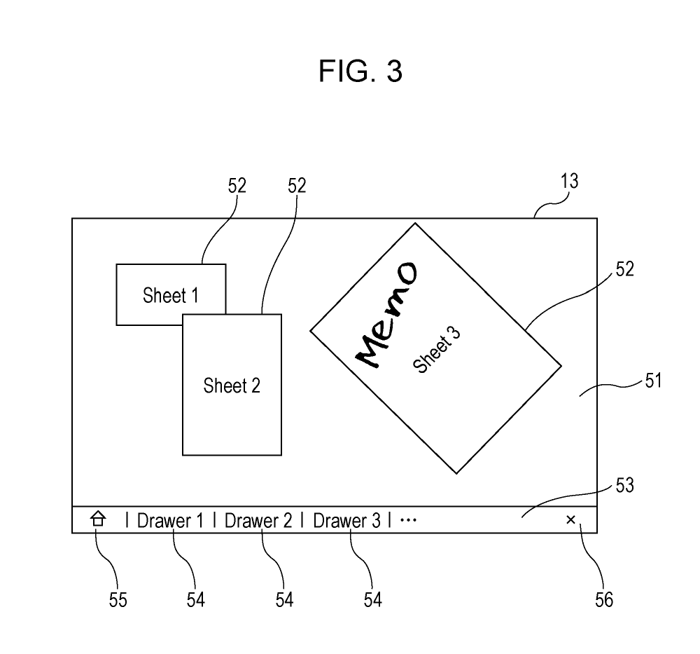

FIG. 3 is an explanatory diagram illustrating a state where material images are displayed on the display unit 13 of the information display device 11 illustrated in FIG. 1. In FIG. 3, display on the display unit 13 mainly includes a work area 51 in an upper portion, a drawer area 53 in a lower end portion, a home menu 55 located to the left of the drawer area 53, and a “close” button 56 located to the right of the drawer area 53. The work area 51 is an area for displaying material images and occupies most of the upper area. In FIG. 3, material images 52 are displayed in the work area 51. The material images 52 are rectangular areas indicated as “sheet 1”, “sheet 2”, and “sheet 3”. A sheet has a rectangular shape and is basically arranged straight in lateral and longitudinal directions; however, a sheet may be handled as a sheet, such as “sheet 3”, for which a rotation operation can be performed.

In the drawer area 53, three drawers 54 are displayed. The three drawers 54 are areas indicated as “drawer 1”, “drawer 2”, and “drawer 3”. When a user touches the area of, for example, “drawer 1”, a list of icons representing pieces of material data stored in “drawer 1” is displayed in the drawer area 53 instead of the list of drawers. When a user touches one of the icons displayed in the list, and drags and drops the icon into the work area 51, a material image corresponding to the icon is displayed at the drop position.

Initially, no file folder is registered in any drawer. After a user has registered a file folder in a drawer, one or more pieces of material data are associated with a selected drawer.

To the left of the drawer area 53, the home menu 55 is provided. When a user touches the home menu 55, a predetermined home menu is displayed.

To the right of the drawer area 53, the “close” button 56 is provided. When a user touches the “close” button 56, the control unit 35 stores the arrangement of material images displayed in the work area 51 at this time point in the arrangement information storing unit 23, ends application software that performs the display process of the information display device 11, and transfers control to the operating system.

Referring back to FIG. 2, a description is further given.

The keyword extraction unit 43 extracts a keyword from at least one of a voice and a material document for a specific subject. For example, if the subject corresponds to a meeting, the keyword extraction unit 43 applies a voice recognition process to voices in the meeting recorded by the microphone 14 and extracts a frequently used word as a keyword. In addition to this process or instead of this process, the keyword extraction unit 43 extracts a frequently appearing word from material data of the meeting or a word used in the title as a keyword (see a fifth embodiment).

The transition information generation unit 45 generates transition information regarding transitions that take place for a subject. For example, if the subject corresponds to a meeting, the transition information generation unit 45 assumes the loudness of voices in the meeting recorded by the microphone 14 as transition information. In general, if a meeting is more active, the voices tend to become louder, and therefore, a clue for finding the point of the meeting can be obtained (see the fifth embodiment).

### Display Process Performed at the Time of Activation of Information Display Device

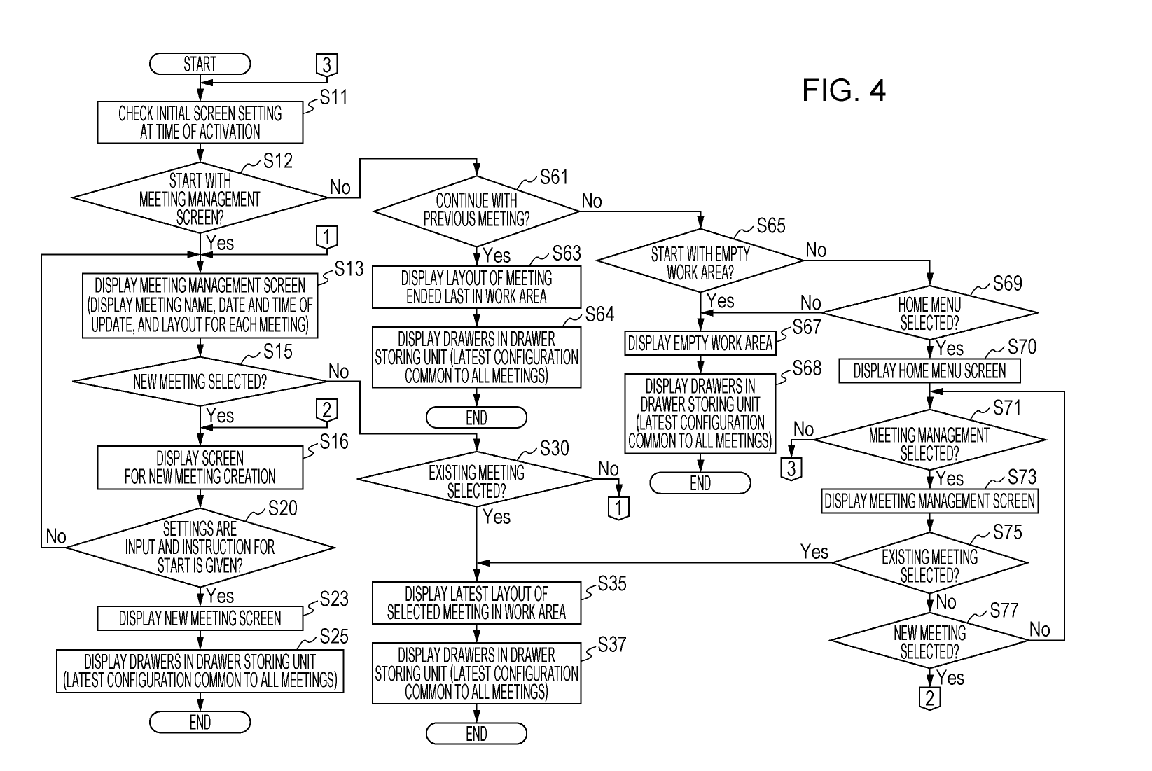

FIG. 4 is a flowchart illustrating an example of a display process performed by the control unit 35 in the first embodiment when the information display device 11 is activated. Hereinafter, a description is given under the assumption that a subject corresponds to a meeting in FIG. 4 to FIG. 11. However, a subject in the present disclosure is not limited to a meeting.

As illustrated in FIG. 4, at the time of activation, the control unit 35 performs control to display a screen for checking an initial screen setting on the display unit 13 (step S11). On the screen, a field in which a user sets one of the three options is provided. The options are provided to set whether a screen for meeting management (meeting management screen) is displayed at the time of activation, the state at the end of the previous meeting is displayed in the work area 51 at the time of activation, or display is started in a state where the work area is empty at the time of activation. When the user sets one of the three options, the control unit 35 may store the setting in the storage unit 21. It may be allowed to set whether the screen for checking the initial screen setting is displayed at the time of the next activation, or such display is omitted and a screen is displayed on the basis of the stored setting. This setting can be changed at any time by selecting “setting” in the home menu.

If the screen is used to perform setting so as to start with the meeting management screen (Yes in step S12) or the meeting management screen is set as default display at the time of activation, the control unit 35 performs the following process. The control unit 35, which functions as the list generation unit 31 and the history list generation unit 33, performs control to display the meeting management screen on the display unit 13 (step S13).

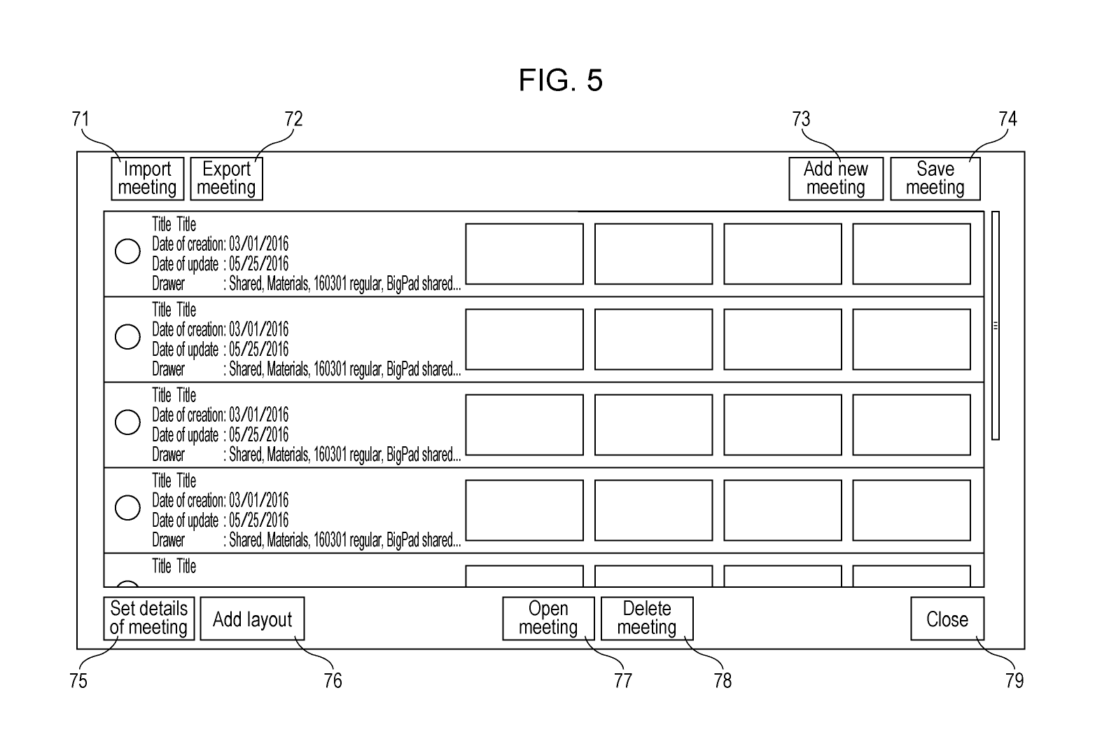

FIG. 5 is an explanatory diagram illustrating an example of the meeting management screen according to the first embodiment. As illustrated in FIG. 5, the meeting management screen is a screen on which, for each meeting, an item that indicates the name of the meeting, which corresponds to a subject, the last date and time when the meeting was held, and a plurality of thumbnails that each indicate the arrangement of sheets displayed in the work area 51 in the meeting are displayed. In the first embodiment, a predetermined number (four in the example in FIG. 5) of thumbnails are displayed for each meeting. For each existing meeting that is displayed on the meeting management screen, a unique ID (the subject might not correspond to a meeting, and therefore, it may be appropriate to call this ID a subject ID; however, this ID is called a meeting ID in the first embodiment) is associated with the meeting. The plurality of thumbnails include the arrangement of sheets at the time when the previous meeting ended, that is, the arrangement of sheets at the last time point, and indicate layouts at several past time points, that is, the arrangements of sheets displayed in the work area 51. In such a mode, thumbnails are displayed so that proceedings in a meeting can be viewed at a glance. Therefore, a user can easily find a meeting that the user wants to retrieve. When an existing meeting is selected and an “open meeting” button 77 is pressed, the latest layout of the selected meeting is retrieved.

On the meeting management screen, various operation buttons are provided.

An “import meeting” button 71 is a button to, when operated, import the content of a meeting and a screen layout stored on an external information display device or an information processing device to the information display device 11. The imported content of a meeting is stored in the storage unit 21 and is processed as a meeting equivalent to a meeting recorded by the information display device 11.

An “export meeting” button 72 is a button to, when operated, export the content of a meeting and a screen layout stored on the information display device 11 to an external information display device or an information processing device. The exported content is data and information related to the selected meeting ID, namely, arrangement information stored in the arrangement information storing unit 23, data stored in the subject storing unit 25, a drawer configuration stored in the drawer storing unit 27, and original material data of material images.

An “add new meeting” button 73 is a button to, when operated, add a new meeting as a management target. In a case where a new meeting is added, the control unit 35 displays an empty work area on the display unit 13.

A “save meeting” button 74 is a button to, when operated, update and save information regarding a meeting that is currently held. The control unit 35 saves the screen layout at this point time as the latest screen layout.

A “set details of meeting” button 75 is a button to, when operated, perform detailed setting related to the attributes of the meeting.

An “add layout” button 76 is a button to, when operated, display a layout management screen for all meetings and to add a screen layout that is selected by a user on the layout management screen to the currently selected meeting.

The “open meeting” button 77 is a button to, when operated, reproduce and display the currently selected meeting.

A “delete meeting” button 78 is a button to delete the currently selected meeting from the meeting management screen. Corresponding data stored in the subject storing unit 25 and the arrangement information storing unit 23 is deleted accordingly. In a case where a drawer configuration is stored for each meeting, corresponding data in the drawer storing unit 27 is also deleted.

A “close” button 79 is a button to, when operated, close the meeting management screen and reopen the previous screen.

Referring back to FIG. 4, a description is further given.

On the meeting management screen, a user can select not only an existing meeting that is stored but also a new meeting (step S15).

If a user selects a new meeting (Yes in step S15), the control unit 35 performs control to display a screen for new meeting creation on the display unit 13 in response to the selection (step S16). On the screen for new meeting creation, the user can set a meeting name and so on.

If settings are input on the screen for new meeting creation and an instruction for opening the meeting is given (Yes in step S20), the control unit 35 stores the meeting name in the subject storing unit 25 and performs control to display an empty work area for a new meeting screen on the display unit 13 (step S23). The control unit 35, which functions as the drawer management unit 41, refers to the drawer storing unit 27 and performs control to display drawers in the drawer area 53 (step S25). Thereafter, the control unit 35 ends the display process performed at the time of activation.

If one of the existing meetings for which thumbnails are displayed is selected on the meeting management screen (Yes in step S30), the control unit 35, which functions as the layout reproduction unit 39, performs the following process. The control unit 35 refers to the arrangement information storing unit 23, and reproduces and displays the latest layout related to the selected meeting in the work area 51 (step S35). The control unit 35, which functions as the drawer management unit 41, refers to the drawer storing unit 27 and displays drawers in the drawer area 53 (step S37). Thereafter, the control unit 35 ends the display process performed at the time of activation.

If selection is made on the screen for initial screen setting so as to display the state at the end of the previous meeting in the work area 51 (No in step S12 and Yes in step S61), the control unit 35, which functions as the layout reproduction unit 39, performs the following process. The control unit 35 refers to the arrangement information storing unit 23, and reproduces and displays the layout at the end of the previously displayed meeting in the work area (step S63). The control unit 35, which functions as the drawer management unit 41, refers to the drawer storing unit 27 and performs control to display drawers in the drawer area 53 (step S64). Thereafter, the control unit 35 ends the display process performed at the time of activation.

If selection is made on the screen for initial screen setting so as to start with an empty work area (No in step S61 and Yes in step S65), the control unit 35 displays an empty work area on the display unit 13 (step S67). The control unit 35, which functions as the drawer management unit 41, refers to the drawer storing unit 27 and performs control to display drawers in the drawer area 53 (step S68). Thereafter, the control unit 35 ends the display process performed at the time of activation.

If none of the three options described above are selected on the screen for initial screen setting and the home menu 55 is touched (No in step S65 and Yes in step S69), the control unit 35 performs control to display a home menu screen (step S70). On the home menu screen, an item “meeting management” is provided. If “meeting management” is selected (Yes in step S71), the control unit 35 performs control to display the meeting management screen on the display unit 13 (step S73). The meeting management screen is a screen similar to the screen displayed in step S13 described above. The home menu screen provides other items, namely, “clear work area”, “layout management”, and “setting”. Here, a description of processes that are performed when these items are selected is omitted. If one of these items is selected (No in step S71), the control unit 35 closes the home menu screen and performs a process for the selected item. Thereafter, the flow returns to step S11.

When a user touches the home menu 55, the user can access the meeting management screen at any time other than the time of activation. The meeting management screen is used to retrieve existing meetings at the time of activation. After activation, the meeting management screen is used to save a layout of a meeting displayed in the work area 51.

If one of the existing meetings for which thumbnails are displayed is selected on the meeting management screen that is displayed via the home menu (Yes in step S75), the flow proceeds to step S35. The control unit 35, which functions as the layout reproduction unit 39, refers to the arrangement information storing unit 23, and reproduces and displays the latest layout related to the selected meeting in the work area 51 (step S35). The control unit 35, which functions as the drawer management unit 41, refers to the drawer storing unit 27 and performs control to display drawers in the drawer area 53 (step S37). Thereafter, the control unit 35 ends the display process performed at the time of activation.

If a new meeting is selected on the meeting management screen displayed via the home menu at the time of activation (No in step S75 and Yes in step S77), the flow proceeds to step S16, and the control unit 35 displays the screen for new meeting creation (step S16). If an existing meeting or a new meeting is not selected (No in step S75 and No in step S77), the flow returns to step S71, and the control unit 35 waits for an item in the home menu to be selected.

The screen process performed at the time of activation is performed as described above.

### Display Process in Information Display Device

Now, an overview of a display process in the information display device 11 performed by the control unit 35 is described. This display process is the overall process including the process performed at the time of activation described with reference to FIG. 4.

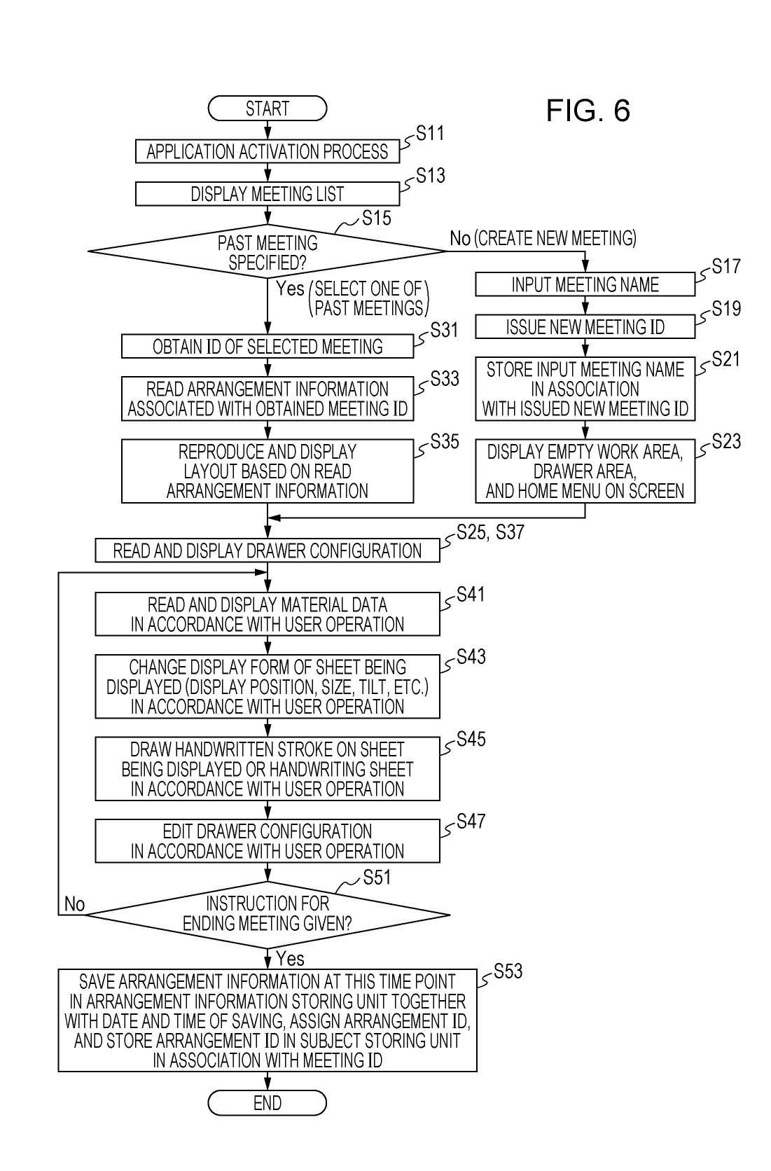

FIG. 6 is a flowchart illustrating an overview of a display process performed by the control unit 35 in the first embodiment. In FIG. 6, a step that corresponds to or is related to a step in FIG. 4 is assigned the same reference numeral as that of the corresponding or related step in FIG. 4.

As illustrated in FIG. 6, the control unit 35 activates application software for controlling screen display of the information display device 11 after activation (step S11). The process in step S11 includes the process in step S11 in FIG. 4. FIG. 6 assumes that setting is performed so as to display the meeting management screen as an initial screen at the time of activation. Therefore, the control unit 35 displays the meeting management screen on the display unit 13 (step S13).

If selection is made on the meeting management screen so as to create a new meeting (No in step S15), the control unit 35 performs control to display the screen for new meeting creation on the display unit 13 and accepts input of a meeting name (step S17). After input of a meeting name, the control unit 35 newly issues an ID (meeting ID), which is an ID used in data management on a per meeting basis (step S19). The control unit 35 stores the newly issued meeting ID in the subject storing unit 25 in association with the meting name (step S21). The control unit 35 performs control to display an empty work area on the display unit 13 (step S23).

The control unit 35 refers to the drawer storing unit 27 and displays drawers in the drawer area 53 (step S25).

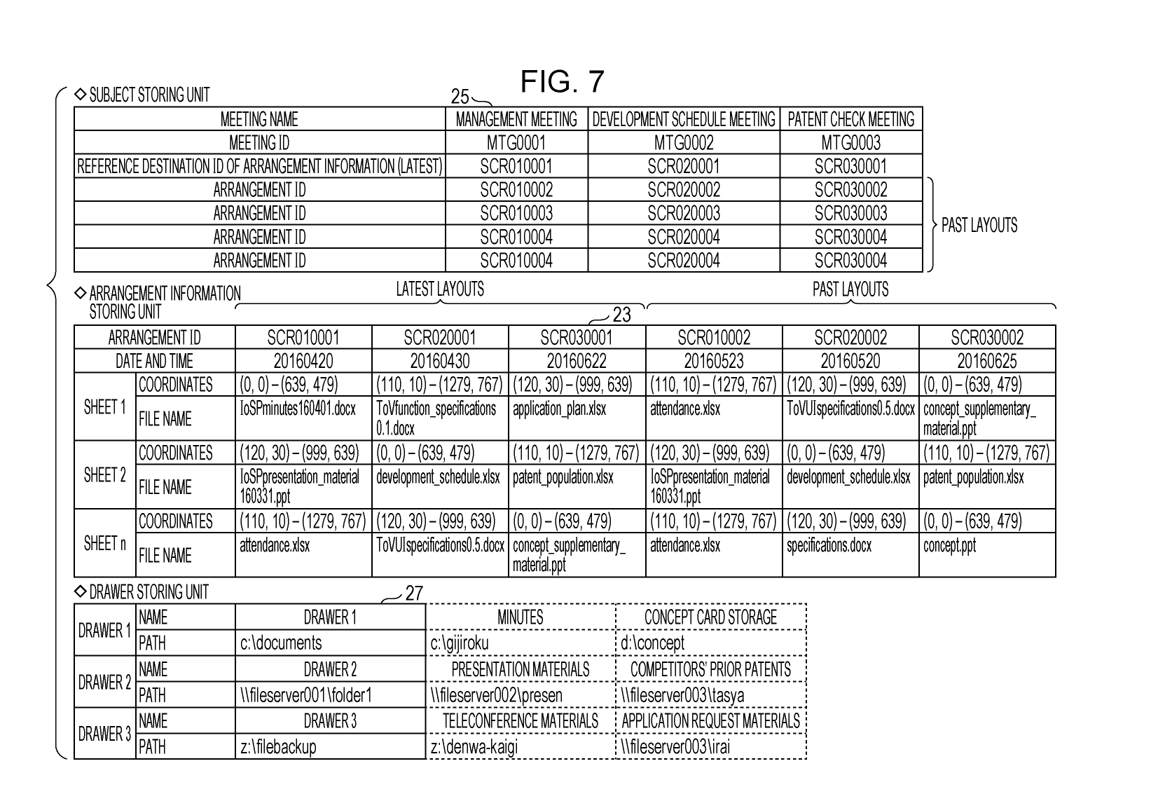

FIG. 7 includes explanatory diagrams illustrating example data stored in the subject storing unit 25, example data stored in the drawer storing unit 27, and example data stored in the arrangement information storing unit 23 in the first embodiment.

In the example of the subject storing unit 25 illustrated in FIG. 7, three meetings are stored. The names of the meetings are “management meeting”, “development schedule meeting”, and “patent check meeting”. To the meetings, unique IDs MTG0001, MTG0002, and MTG0003 are assigned. For each meeting, IDs of pieces of arrangement information (arrangement IDs) associated with the meeting are registered. At the time when a new meeting is registered, only the latest piece of arrangement information is present. For a meeting held in the past, pieces of arrangement information at the times when a saving process was performed are registered as a history. As a meeting proceeds, a piece of arrangement information may be added if a predetermined condition is satisfied. The predetermined condition may be, for example, a condition that a new material image is opened, a condition that a material image is closed, or a condition that the layout changes from the previous layout after the elapse of a predetermined time period.

Referring back to FIG. 6, a description is further given.

If an existing meeting, that is, one of the existing meetings registered in the subject storing unit 25, is selected on the meeting management screen (Yes in step S15), the control unit 35 obtains the meeting ID of the selected meeting (step S31). The control unit 35 refers to the arrangement information storing unit 23 and reads a piece of arrangement information associated with the obtained meeting ID from the arrangement information storing unit 23 (step S33). The control unit 35 reproduces and displays sheets in the work area 51 in accordance with the positions and sizes (and the angles of tilts if a rotation operation can be performed) of the sheets based on the read piece of arrangement information (step S35).

FIG. 7 illustrates example data stored in the arrangement information storing unit 23. Each piece of arrangement information has a unique ID (arrangement ID) that corresponds to the time point when the piece of arrangement information was stored, and sheets that were displayed in the work area 51 at the time point share the arrangement ID. Each piece of arrangement information includes a date and time when the piece of arrangement information was stored. Each piece of arrangement information further includes, for each sheet, a parameter that indicates at least one of the position, size, and tilt of the sheet. Each piece of arrangement information further includes, for each sheet, a parameter used to identify original material data of the sheet. In the example illustrated in FIG. 7, diagonal coordinates that indicate the position and size of each sheet are stored. To simplify description, the example illustrated in FIG. 7 assumes that all sheets have a rectangular shape and do not allow a rotation operation. Therefore, diagonal coordinates that indicate the position and size of each sheet and a file name that indicates the original material data are included in arrangement information. In a case of handling a sheet having a shape other than a rectangular shape or in a case of allowing a rotation operation, more complex arrangement information is stored accordingly.

The control unit 35 refers to the drawer storing unit 27 and displays drawers in the drawer area 53 (step S37).

The process in each step in FIG. 6 described above is the display process performed at the time of activation. After completion of the display process performed at the time of activation, the control unit 35 accepts an operation performed on a sheet displayed in the work area 51, a drawer displayed in the drawer area 53, the home menu 55, or the “close” button 56.

For example, if a user operates a drawer to newly select a piece of material data and performs an operation of dragging and dropping the icon of the piece of material data into the work area 51, the control unit 35 performs the following process in response to the operation. The control unit 35, which functions as the material image generation unit 37, obtains the address of the selected piece of material data from the drawer storing unit 27 and opens the piece of material data. The control unit 35 generates an image of the opened piece of material data and displays a sheet generated as the image in the work area 51 (step S41).

FIG. 7 illustrates example data stored in the drawer storing unit 27. In the example illustrated in FIG. 7, three drawers are present, and the names of the drawers are “drawer 1”, “drawer 2”, and “drawer 3”. In the first embodiment, a file path associated with each drawer is common to all subjects regardless of the selected subject. The drawer storing unit 27 stores, for each drawer, the path of a file folder in which files are stored.

A different mode may be employed in which the drawer storing unit 27 is configured such that each drawer corresponds to a meeting (subject). The details of this mode will be described as another embodiment (see the third embodiment). In FIG. 7, the portion outlined by a chain line indicates a configuration in a case where different reference destinations of material data are stored in respective drawers for respective meetings.

Referring back to FIG. 6, a description is further given.

In a case where a user selects a sheet displayed in the work area 51 and performs, for example, an operation of dragging and moving the sheet, an operation of enlarging or reducing the sheet by zooming, or an operation of rotating the sheet to change the tilt, the control unit 35 performs the following process. The control unit 35 moves, enlarges or reduces, or rotates the sheet displayed in the work area 51 in accordance with the operation (step S43).

In a case where the user does not select a sheet but keeps their fingertip or the tip of an electronic pen in contact with the area of a sheet displayed in the work area 51 and moves the position of contact, the control unit 35 draws a handwritten stroke corresponding to the position of contact in the work area 51 (step S45). A material image and a handwritten stroke are managed as images on different layers.

The user can display a blank sheet in the work area 51 and draw a handwritten stroke in the area of the sheet. By performing such an operation, the sheet can be used as a handwritten note.

In a meeting, a user can display a sheet in the work area 51, change the arrangement of a sheet, and draw a handwritten stroke on a sheet by using the above-described functions.

Further, a user can touch the home menu 55 to display the home menu. The home menu includes a plurality of menus, and the plurality of menus include “meeting management”. In the case where “meeting management” is selected after activation, the control unit 35 stores the layout of a meeting displayed in the work area 51 in the arrangement information storing unit 23. In a case of ending a meeting, a user can select “meeting management” from the home menu to store the layout.

When a user performs an operation of editing a drawer configuration, such as an operation of adding a piece of material data to a drawer or an operation of deleting a piece of material data from a drawer, the control unit 35 accesses the drawer storing unit 27 and changes the configuration in accordance with the operation (step S47). In the first embodiment, a drawer configuration that is common to all meetings is employed.

If “meeting management” is selected from the home menu (Yes in step S51), the control unit 35 performs the following process. The control unit 35 stores the layout at this time point, that is, the arrangement (position, size, and tilt in a case where a rotation operation is allowed) of a sheet displayed in the work area 51 in the arrangement information storing unit 23 together with the date and time of storage. The control unit 35 assigns a new arrangement ID so as to distinguish the piece of arrangement information at this time point from a piece of arrangement information at a different time point. The control unit 35 stores the arrangement ID in the subject storing unit 25 in association with the corresponding meeting in which display has been performed in accordance with the layout. Specifically, the control unit 35 stores the arrangement ID in the subject storing unit 25 in association with the meeting ID (step S53).

The display process is performed as outlined above.

### Display Process Performed at the Time of Ending or Saving

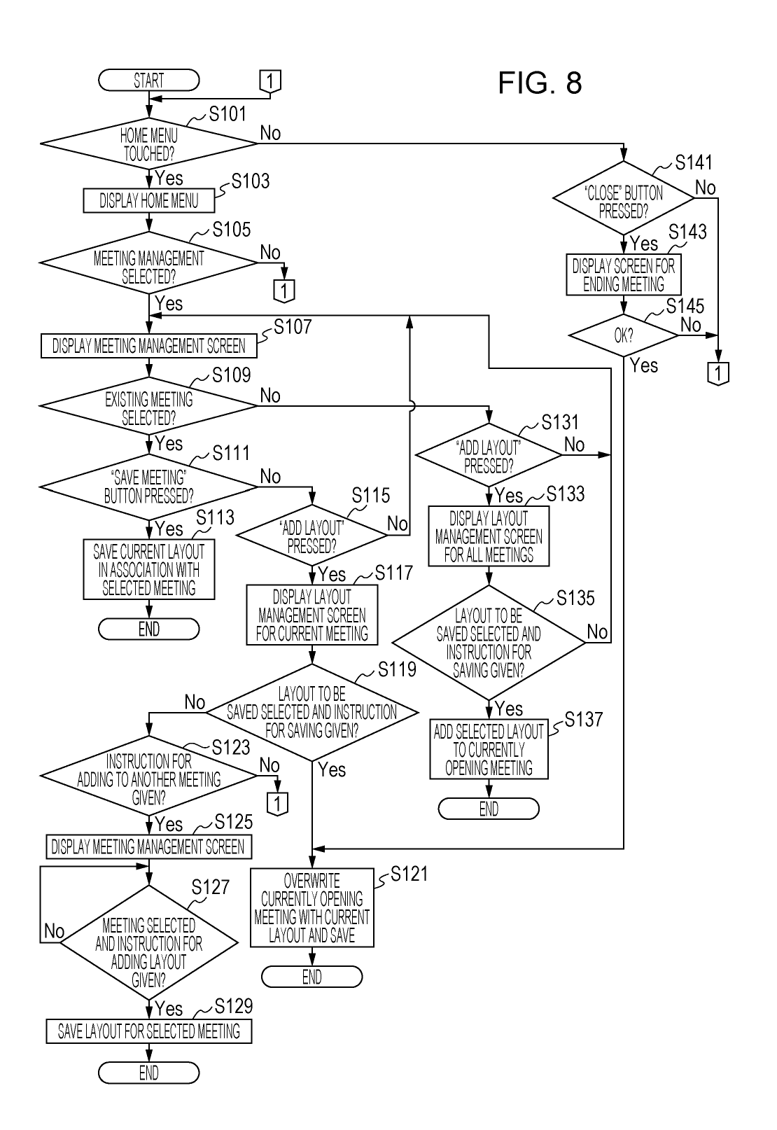

FIG. 8 is a flowchart illustrating an example of a process performed by the control unit 35 in the first embodiment when a meeting ends. The flowchart includes a process corresponding to the process in step S53 in FIG. 6. The process performed at the time when display ends is described with reference to FIG. 8.

As illustrated in FIG. 8, if a user touches the home menu 55 at the end of a meeting (Yes in step S101), the control unit 35 displays the home menu on the display unit 13 (step S103).

If “meeting management” is selected from among the items of the home menu (Yes in step S105), the control unit 35 displays the meeting management screen on the display unit 13 (step S107). If the user selects one of the existing meetings displayed on the meeting management screen (Yes in step S109), the control unit 35 waits for the next operation to be performed for the selected meeting.

As illustrated in FIG. 5, the “save meeting” button 74 is provided on the meeting management screen. If the user selects the “save meeting” button 74 (Yes in step S111), the control unit 35 saves the arrangement of sheets displayed in the work area 51 in an area of the arrangement information storing unit 23, the area corresponding to the selected meeting, as the latest piece of arrangement information (step S113), and ends the process.

On the meeting management screen, the “add layout” button 76 is provided. If an existing meeting is selected, and the user touches the “add layout” button 76 (No in step S111 and Yes in step S115), the control unit 35 displays the layout management screen for displaying the history of layouts of the currently selected meeting as a list on the display unit 13 (step S117). If one of the layouts displayed on the layout management screen is selected (Yes in step S119), the control unit 35 performs the following process. The control unit 35 deletes a piece of arrangement information having the selected arrangement ID from the arrangement information storing unit 23 and adds a piece of arrangement information regarding the current layout (step S121). That is, the control unit 35 replaces the selected piece of arrangement information with the piece of arrangement information at the current time point. Thereafter, the control unit 35 ends the process.

On the layout management screen, an option for displaying the history of layouts of a meeting other than the currently selected meeting is provided. If the option is selected (No in step S119 and Yes in step S123), the control unit 35 displays the meeting management screen on the display unit 13 (step S125) and accepts selection of another meeting (step S127). If a meeting is selected, the control unit 35 displays the layout management screen for the meeting. If one of the layouts of the meeting is selected, the control unit 35 updates the piece of arrangement information regarding the selected meeting having the selected arrangement ID with a piece of arrangement information regarding the current layout (step 129). Thereafter, the control unit 35 ends the process.

If an existing meeting is not selected, and the “add layout” button 76 is touched (No in step S109 and Yes in step S131), the control unit 35 displays the layout management screen for all meetings on the display unit 13 (step S133). The control unit 35 waits for one of the layouts of one of the meetings to be selected (step S135). If selection is made (Yes in step S135), the control unit 35 adds the selected layout to the currently selected meeting (step S137). Thereafter, the control unit 35 ends the process.

On the display unit 13, the “close” button 56 is provided. The “close” button 56 is provided to the right of the drawer area 53. If the “close” button 56 is touched (No in step S101 and Yes in step S141), the control unit 35 displays a screen for ending a meeting on the display unit 13 (step S143). The screen for ending a meeting includes a message “the current meeting is saved and ended” and options of “OK” and “cancel”. If “OK” is selected (Yes in step S145), the flow proceeds to step S121. The control unit 35 adds the latest layout of the current meeting to the arrangement information storing unit 23 (step S121). Thereafter, the control unit 35 ends the process.

The process performed at the time of ending is performed as described above.

### Summarization of Management Based on Subject

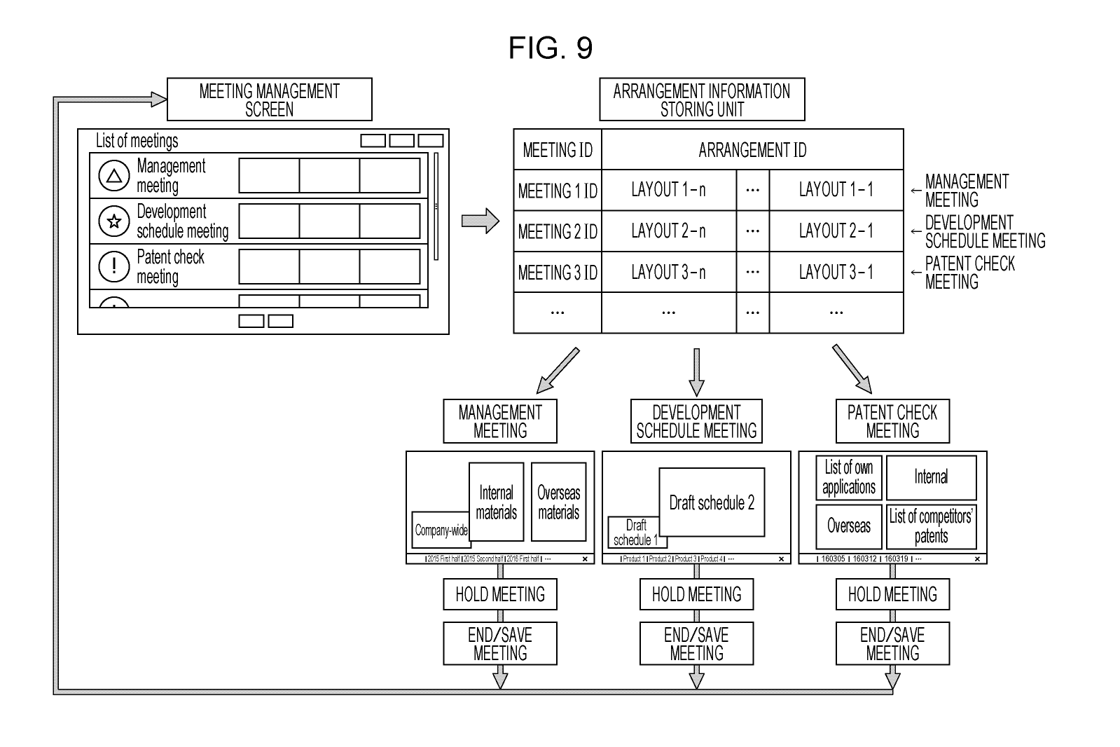

FIG. 9 is an explanatory diagram illustrating points of the display process according to the first embodiment. A user can select a meeting on the meeting management screen, which is the “meeting management screen” in FIG. 9. As illustrated in the “arrangement information storing unit” in FIG. 9, the selected meeting is associated with pieces of arrangement information in the arrangement information storing unit. In the arrangement information storing unit, past layouts as well as the latest layout are stored. A meeting and a layout are associated with each other by storing the arrangement ID of the layout in the subject storing unit in association with the meeting ID of the meeting.

When a user selects a meeting on the meeting management screen, one or more sheets are reproduced and displayed in the work area 51 on the basis of the latest layout associated with the meeting.

When the meeting ends, the layout at the time of ending is stored as the latest layout. Alternatively, as in the display process at the time of ending described with reference to FIG. 8, the layout at the time of ending can replace a past layout in the history or can be saved in another meeting. A layout of another meeting can be copied and added.

### Second Embodiment

In the first embodiment, thumbnails are displayed on the meeting management screen so that transitions of material images displayed in each meeting can be viewed at a glance. These thumbnails are only reference information for selecting a meeting.

In the second embodiment, a user can use thumbnails that indicate transitions of material images to select a layout at a specific time point for which display is to be reproduced.

As illustrated in FIG. 7, the arrangement information storing unit 23 stores, for each meeting, a piece of arrangement information at the last time point and pieces of arrangement information at past time points.

In the second embodiment, the control unit 35 recognizes a thumbnail that is touched on the meeting management screen among the thumbnails that indicate a history and obtains an arrangement ID that corresponds to the thumbnail. The control unit 35 refers to a piece of arrangement information having the arrangement ID among the pieces of arrangement information stored in the arrangement information storing unit 23, and reproduces and displays sheets in the work area 51.

A user selects and touches a thumbnail among the thumbnails on the meeting management screen. Accordingly, the user can specify a thumbnail of a specific meeting at a specific time point for which display is to be reproduced. If the user wants to reproduce the latest screen arrangement, the user needs to touch the thumbnail at the last time point. If the user wants to reproduce a past screen arrangement, the user needs to touch a thumbnail at a corresponding past time point.

### Third Embodiment

In the first embodiment, a drawer configuration is common to all subjects regardless of a selected subject. In the third embodiment, a drawer configuration as well as a screen layout is reproduced and displayed for each selected subject.

Therefore, in the third embodiment, the drawer storing unit 27 is configured as illustrated by the portion outlined by a chain line in FIG. 7. The name and the path of a drawer are stored for each meeting.

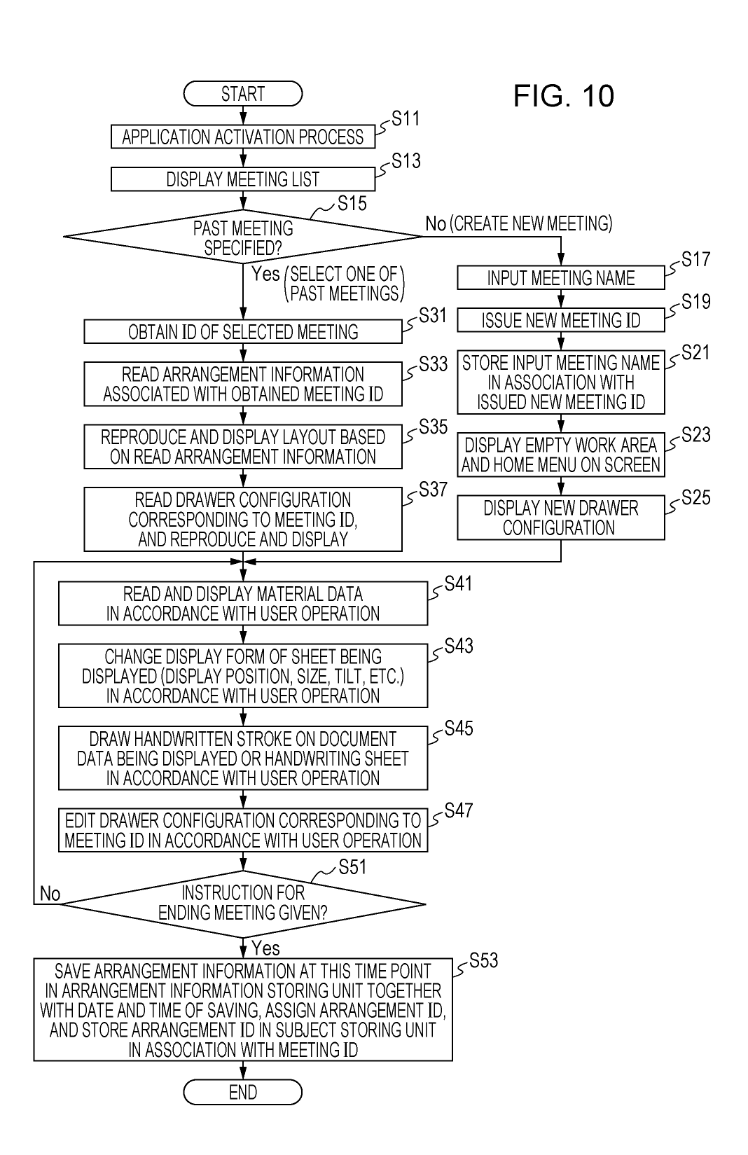

FIG. 10 is a flowchart illustrating an overview of a display process performed by the control unit 35 in the third embodiment, and corresponds to FIG. 6. Only steps different from those in FIG. 6 according to the first embodiment are described.

In FIG. 10, if a new meeting is selected on the meeting management screen after activation (No in step S15), the control unit 35 performs the following process. The control unit 35 displays an empty work area, and thereafter, displays a new drawer configuration, that is, a drawer that is not associated with any file folder in the drawer area 53 (step S25).

If an existing meeting is selected (Yes in step S15), the control unit 35 performs the following process. The control unit 35 reproduces and displays a screen layout of the selected meeting in the work area 51, and thereafter, refers to the drawer storing unit 27 and reproduces and displays a drawer configuration that corresponds to the meeting ID in the drawer area 53 (step S37).

After activation, when a user performs an operation of editing the drawer configuration, such as an operation of adding a piece of material data to the drawer or an operation of deleting a piece of material data from the drawer, the control unit 35 performs the following process in accordance with the operation. The control unit 35 accesses the drawer storing unit 27 and changes the drawer configuration that corresponds to the selected meeting ID (step S47). In the third embodiment, a drawer configuration is set for each meeting.

Each time a change operation is performed for a drawer configuration, the control unit 35 updates the drawer configuration corresponding to the meeting ID in the drawer storing unit 27, and therefore, need not update the drawer configuration at the time when the meeting ends.

### Fourth Embodiment

In the first embodiment, the display unit 13 is constituted by one display device; however, there may be a case where a plurality of display devices are arranged so as to constitute one display unit 13, that is, to implement multi-display. There may be a mode in which a plurality of display devices are arranged closely to imaginarily form a single large screen. There may be another mode in which, even if a plurality of display devices are present at places physically distant from each other, display is performed as if the plurality of display devices are adjacent to each other. Both of the modes correspond to multi-display according to the fourth embodiment.

In the first to third embodiments, a user can select only one meeting or one thumbnail (a screen layout at a specific time point) on the meeting management screen. In the fourth embodiment, a user can select a plurality of meetings or a plurality of thumbnails.

The maximum number of meetings or thumbnails that can be selected does not exceed the number of display devices that constitute the multi-display device.

The control unit 35 displays a plurality of selected screen layouts on the respective different display devices such that each screen layout is displayed on one screen. That is, the control unit 35 displays one selected screen layout on one display device without dividing and displaying the screen layout on the plurality of display devices.

### Fifth Embodiment

In the first to fourth embodiments, as a reference used by a user to select a meeting on the meeting management screen, a history of layouts that are represented by thumbnails is displayed. In the fifth embodiment, examples of reference information that is displayed instead of or in addition to the history of layouts are given.

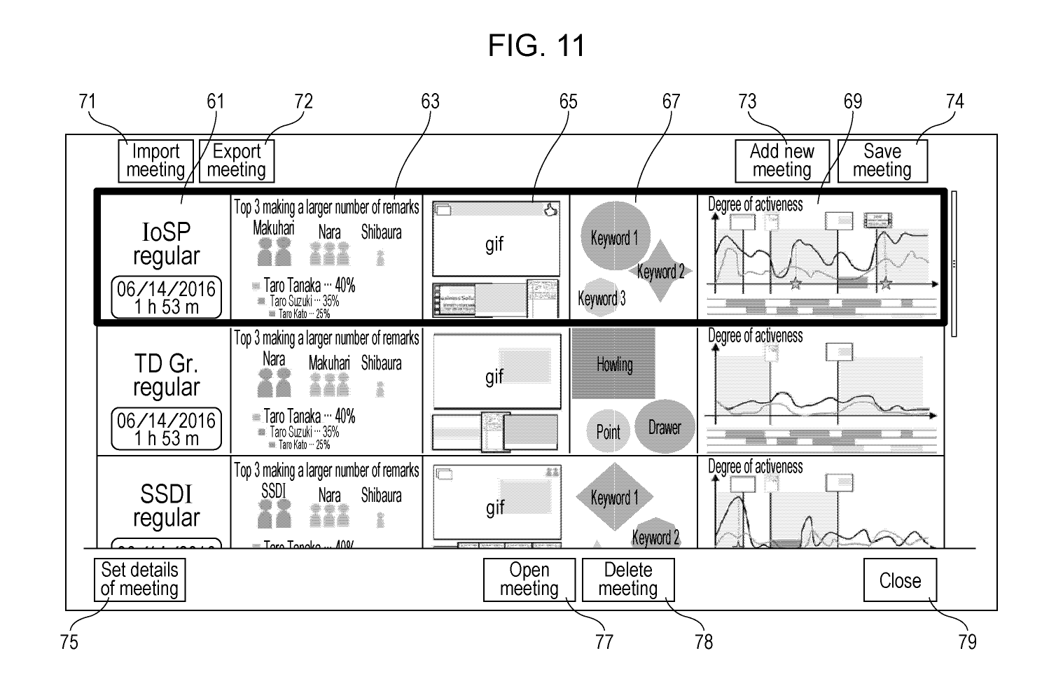

FIG. 11 is an explanatory diagram illustrating an example of the meeting management screen according to the fifth embodiment. The meetings are teleconferences held by connecting three remote sites with each other via communication. As illustrated in FIG. 11, on the meeting management screen, three meetings named “IoSP regular”, “TD Gr. regular”, and “SSDI regular” are displayed. When the screen is scrolled downward by using the scroll bar in the right end portion, other meetings that are hidden in FIG. 11 are displayed.

Reference information regarding, for example, the “IoSP regular” meeting displayed at the top is described. In the leftmost field assigned reference numeral 61, the name of the meeting “IoSP regular”, the last date and time when the meeting was held “06/14/2016”, and the duration of the meeting “1h53m” (1 hour and 53 minutes) are displayed.

In the field assigned reference numeral 63, which is located to the right of the field 61, the number of participants of the meeting is indicated for each site. Specifically, the proportion of the number of remarks made in each site, the names of the top three persons who made a larger number of remarks, and the percentage of remarks made by each of the three persons in the entire meeting are displayed. This reference information is obtained by making the participants use different microphones and analyzing voices recorded by each microphone.

In the field assigned reference numeral 65, which is located to the right of the field 63, thumbnails of representative images and materials used in the meeting are displayed. In FIG. 11, a plurality of thumbnails are displayed. As another example of the display method, a plurality of thumbnails may be sequentially displayed one after another in a slideshow-like manner in one display area.

In the field assigned reference numeral 67, which is located to the right of the field 65, keywords frequently used in the remarks made in the meeting or in material data are extracted and displayed. A process for extracting keywords from remarks can be implemented by using, for example, a voice recognition technique.

In the rightmost field assigned reference numeral 69, a graph that indicates the degree of activeness relative to progress in the meeting is displayed. The vertical axis represents the degree of activeness, and the horizontal axis represents time. Below the horizontal axis of the graph, periods during which the extracted keywords are used are displayed in accordance with the time axis. The timing at which a new material image is displayed in the meeting is indicated by an icon of the material image.

The curve that represents the degree of activeness is based on the volume of recorded voices. That is, the control unit 35, which functions as the transition information generation unit 45, determines that the meeting is active when the volume of voices is high and generates a graph that indicates the degree of activeness.

When a new material image is displayed in the meeting, the screen layout changes. Accordingly, a user may be allowed to touch and select a section between the icons of material images superimposed on the graph of the degree of activeness. Then, the control unit 35 may display a screen layout corresponding to the touched section in the field 65.

As illustrated in FIG. 11, when keywords and the degree of activeness are displayed as well as transitions in the screen arrangement, the user can easily recall the content of the meeting or proceedings in the meeting and select a desired meeting.

As described above, (i) an information display device according to the present disclosure includes a display unit that simultaneously displays one or more images; a storage unit that stores one or more pieces of arrangement information each indicating an arrangement of the one or more images displayed on the display unit on a per image basis, each of the one or more pieces of arrangement information being associated with a subject among one or more subjects related to storage and reproduction of display content; a list generation unit that generates a subject-basis list so as to allow selection of an arrangement of one or more images to be reproduced on the display unit for a subject among the one or more subjects; an operation unit that accepts selection of a subject from among the one or more subjects by a user using the subject-basis list; and a layout reproduction unit that reproduces an arrangement of one or more images on the display unit on the basis of a piece of arrangement information associated with the selected subject.

In the present disclosure, material data is a data file of any of the various types of documents (that may include an image) created by using software, such as presentation software, document creation software, spreadsheet software, drawing software, or a text editor. Specific examples of material data include text data created by using a text editor and PDF data obtained by converting the text data to data in a PDF format. Material data can be opened by using corresponding application software.

A material image (also called a sheet) is image data obtained by converting material data described above to an image, and is associated with the original material data. A material image is image data, and therefore, can only be, for example, moved, enlarged/reduced, or rotated and displayed. For example, in order to respond to a request for, for example, a page flip, a process for opening the original material data, converting the next page to an image, and replacing the material image currently displayed on the display unit with the image obtained as a result of the conversion needs to be performed.

Arrangement information includes geometric attributes used to reproduce display of a material image on the display unit and includes, for example, the position, size, and tilt of the material image. If only a case is assumed where display is reproduced on the same display unit at all times, only the absolute position, size, and tilt of each material image need to be stored. If a case is taken into consideration where display is reproduced on a different display unit having different dimensions or a different aspect ratio, arrangement information that is modified so as to indicate attributes, namely, the ratio between the height of the display unit and that of a material image and the ratio between the width of the display unit and that of the material image may be used.

The storage unit is a nonvolatile storage device that is constituted by at least a flash memory or a hard disk drive, and is capable of storing the arrangement of material images displayed on the display unit at a past specific time point.

A thumbnail is obtained by reducing an image or text.

A portion responsible for display and a portion responsible for information processing need to be connected via, for example, communication and functionally integrated and need not be physically integrated.

Other aspects of the present disclosure are described below.

(ii) The list generation unit may generate a list of arrangements of one or more images for each of the one or more subjects as a history so as to allow the user to select an arrangement of one or more images at a past specific time point for one of the one or more subjects. The layout reproduction unit may reproduce an arrangement of one or more images and display content on the display unit on the basis of selection of a subject and a time point for which a screen is to be reproduced, the selection being accepted by the operation unit.

Accordingly, a user can easily distinguish images related to different subjects from each other and can select a screen of a specific subject at a specific time point to be reproduced to easily reproduce a corresponding arrangement of images and the content of display on the display unit.

(iii) Each of the one or more subjects may be related to a topic of a meeting, a lecture, a speech, a lesson, or a presentation, or may be an item similar to a topic of a meeting, a lecture, a speech, a lesson, or a presentation.

(iv) The information display device may further include a drawer management unit that displays one or more pieces of material data so as to allow the user to make selection, the one or more pieces of material data being one or more pieces of original data of the one or more images. The storage unit may store one or more pieces of address information that each indicate a storage destination in which the one or more pieces of material data are stored. The drawer management unit may display the one or more pieces of address information as units on the display unit so as to allow the user to select one or more pieces of material data stored together in one of the units, display, in a case where one of the units is selected, one or more pieces of material data belonging to the selected unit on the display unit so as to allow the user to further make selection, and form, in a case where a piece of material data is selected, an image of the selected piece of material data as a material image and display the material image on the display unit.

Accordingly, a user can not only easily reproduce the arrangement of one or more material images for a specific subject at a past specific time point but also select one piece of material data from among the pieces of material data stored together as a unit that corresponds to, for example, a specific subject to display a material image corresponding to the piece of material data on the display unit.

(v) The display unit may be formed by arranging a plurality of display devices. The operation unit may accept selection of a plurality of options among options displayed in a list. The layout reproduction unit may reproduce screens corresponding to the respective selected options on different display devices among the plurality of display devices.

Accordingly, in a multi-display configuration in which a plurality of display devices are arranged, screens corresponding to different options can be reproduced and displayed on the respective displays. The different options may correspond to, for example, screens for different subjects or screens for the same subject at different time points.

(vi) The information display device may further include a keyword extraction unit that extracts a keyword on the basis of at least one of a voice and a material document for a specific subject. The list generation unit may generate the subject-basis list to which the extracted keyword is added.

Accordingly, when selecting a subject from a subject-basis list, a user can easily find a desired subject by referring to a keyword added to the subject-basis list.

(vii) The information display device may further include a transition information generation unit that generates transition information regarding transitions in a specific subject. The list generation unit may generate the subject-basis list to which the generated transition information is added.

Accordingly, when selecting a subject from a subject-basis list, a user can easily find a desired subject by referring to transition information added to the subject-basis list.

Aspects of the present disclosure also include a combination of any of the plurality of aspects described above.

In addition to the embodiments described above, various modifications can be made to the present disclosure. Such modifications are understood to fall within the scope of the present disclosure. The present disclosure includes the equivalents of the claims and all modifications that fall within the scope of the present disclosure.

The present disclosure contains subject matter related to that disclosed in Japanese Priority Patent Application JP 2016-211668 filed in the Japan Patent Office on Oct. 28, 2016, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information display device comprising:
a display unit that simultaneously displays one or more images;
a storage unit that stores one or more pieces of arrangement information each indicating an arrangement of the one or more images displayed on the display unit on a per image basis, each of the one or more pieces of arrangement information being associated with a subject among one or more subjects related to storage and reproduction of display content;
a list generation unit that generates a subject-basis list so as to allow selection of an arrangement of one or more images to be reproduced on the display unit for a subject among the one or more subjects;
an operation unit that accepts selection of a subject from among the one or more subjects by a user using the subject-basis list; and
a layout reproduction unit that reproduces an arrangement of one or more images on the display unit on the basis of a piece of arrangement information associated with the selected subject.

2. The information display device according to claim 1, wherein
the list generation unit generates a list of arrangements of one or more images for each of the one or more subjects as a history so as to allow the user to select an arrangement of one or more images at a past specific time point for one of the one or more subjects, and
the layout reproduction unit reproduces an arrangement of one or more images and display content on the display unit on the basis of selection of a subject and a time point for which a screen is to be reproduced, the selection being accepted by the operation unit.

3. The information display device according to claim 1, wherein
each of the one or more subjects is related to a topic of a meeting, a lecture, a speech, a lesson, or a presentation.

4. The information display device according to claim 1, further comprising
a drawer management unit that displays one or more pieces of material data so as to allow the user to make selection, the one or more pieces of material data being one or more pieces of original data of the one or more images, wherein
the storage unit stores one or more pieces of address information that each indicate a storage destination in which the one or more pieces of material data are stored, and
the drawer management unit displays the one or more pieces of address information as units on the display unit so as to allow the user to select one or more pieces of material data stored together in one of the units, displays, in a case where one of the units is selected, one or more pieces of material data belonging to the selected unit on the display unit so as to allow the user to further make selection, and forms, in a case where a piece of material data is selected, an image of the selected piece of material data as a material image and displays the material image on the display unit.

5. The information display device according to claim 1, wherein
the display unit is formed by arranging a plurality of display devices,
the operation unit accepts selection of a plurality of options among options displayed in a list, and
the layout reproduction unit reproduces screens corresponding to the respective selected options on different display devices among the plurality of display devices.

6. The information display device according to claim 1, further comprising
a keyword extraction unit that extracts a keyword on the basis of at least one of a voice and a material document for a specific subject, wherein
the list generation unit generates the subject-basis list to which the extracted keyword is added.

7. The information display device according to claim 1, further comprising
a transition information generation unit that generates transition information regarding transitions in a specific subject, wherein
the list generation unit generates the subject-basis list to which the generated transition information is added.

8. An information display method comprising:
simultaneously displaying one or more images;
storing one or more pieces of arrangement information each indicating an arrangement of the displayed one or more images on a per image basis, each of the one or more pieces of arrangement information being associated with a subject among one or more subjects related to storage and reproduction of display content;
generating a subject-basis list so as to allow selection of an arrangement of one or more images to be reproduced and displayed for a subject among the one or more subjects;
accepting selection of a subject from among the one or more subjects by a user using the subject-basis list; and
reproducing and displaying an arrangement of one or more images on the basis of a piece of arrangement information associated with the selected subject.

9. A non-transitory recording medium storing a program causing a computer to execute a process, the process comprising:
simultaneously displaying one or more images;
storing one or more pieces of arrangement information each indicating an arrangement of the displayed one or more images on a per image basis, each of the one or more pieces of arrangement information being associated with a subject among one or more subjects related to storage and reproduction of display content;
generating a subject-basis list so as to allow selection of an arrangement of one or more images to be reproduced and displayed for a subject among the one or more subjects;
accepting selection of a subject from among the one or more subjects by a user using the subject-basis list; and
reproducing and displaying an arrangement of one or more images on the basis of a piece of arrangement information associated with the selected subject.
